(19) United States
(12) Patent Application Publication
(10) Pub. No.: US 2017/0069410 A1
(43) Pub. Date: Mar. 9, 2017

(54) ARRANGEMENT FOR ELECTRICALLY CONNECTING ELECTRICAL DEVICES

(71) Applicant: NEXANS, Paris (FR)

(72) Inventors: Helmut Steinberg, Stornstein (DE); Udo Mayer, Weiden (DE)

(21) Appl. No.: 14/829,831

(22) Filed: Aug. 19, 2015

(30) Foreign Application Priority Data
Sep. 5, 2014 (EP) 14 306 368.3

(51) Int. Cl. H01B 11/18; G01D 5/26; H02G 3/22; H01B 11/22; H02G 3/04; H01B 7/20

(52) U.S. Cl. CPC H01B 11/1895; H02G 3/0468; H01B 7/202; H02G 3/22; H01B 11/22; G01D 5/268

(57) ABSTRACT

An arrangement is provided for electrically connecting two devices (2, 3) located in a plant. Between the two electrical devices (2, 3) at least one electric line (4) formed of metal is arranged between the two electrical devices (2, 3) surrounded by a screen. The screen, (5) is constructed as metal pipe (5) which is at least partially undulated and is connected at both, ends each with an electrically conductive housing of the two electrical devices (2, 3).

### RELATED APPLICATION

This application claims the benefit of priority from European Patent Application. No. 14 306 363.3, filed on Sep. 5, 2014, the entirety of which is incorporated by reference.

### BACKGROUND

Field of Invention

The invention relates to an arrangement for electrically connecting two electrical devices contained in a plant, wherein between the two electrical devices is arranged at least one electrical line surrounded by a screen.

Description of the Related Art

The electrical lines or strands are electrical conductors surrounded by insulation. The mentioned arrangement is used in electrical devices of all types and particularly in motor vehicles. For example, using a single electrical line in an electrical vehicle or hybrid motor vehicle, the direct current battery can be connected. electrically to an inverter. The inverter, in turn, can be connected to the electric motor by means of a three phase system, i.e. with three electrical lines, which preferably are connected to form a cable set. In this manner, the electric motor can be supplied by the direct current battery through the inverter with alternating current.

In the plant, for example, in the motor vehicle, the electrical lines are mechanically secured during the manufacturing process. For example, individual or multiple lines can be surrounded by a flexible plastic pipe. Several lines combined to form cable set, may also be surrounded by a shrink on hose or can be surrounded by an adhesive tape. However, such circumferential sleeves do not provide a sufficient mechanical protection of the line or lines in the case of higher mechanical stress which may caused, for example, by vibrations, objects with sharp edges, or during the installation of the lines. Moreover, they do not have the structural stiffness required for use in a motor vehicle.

DE 30 42 177 A1 describes a cable tree for electrically conductively connecting a current source to several current users in a device. In a cable tree the electrical lines are combined into a mechanical unit and, in the area in which the lines are arranged parallel to each other, the lines are surrounded by an undulated metal pipe. The undulated metal pipe has the purpose of protecting the conductors against mechanical loads and to provide the cable tree with a good bending property.

In order to prevent or reduce the radiation and irradiation of undesirable electromagnetic fields, the line or the plurality of lines are provided with a screen. The screen may consist, for example, of a non-woven fabric of copper which is formed around the line or the plurality of lines. The electrical lines can also be arranged already with a screen.

The metal pipe described in the above mentioned DE 30 42 177 A1 is not suitable for an effective screening. Since the metal pipe extends only over a central portion of the plurality of lines which extend parallel, the areas where the lines are connected to the user or current source remain unscreened.

### OBJECTS AND SUMMARY

The invention is based on the object of making available an arrangement of two electrical devices contained in a plant, so that a complete electromagnetic screening without gaps of the at least one line and the electrical components connected thereto is ensured, and wherein the at least one electrical line can be geometrically determined.

In accordance with the invention, the above mentioned object is met in that the above mentioned screening is constructed as a metal pipe which is at least partially undulated and is connected without gaps at the two ends thereof with electrically conductive housings of the electrical devices.

The at least partially undulated metal pipe serves as a circumferentially closed electric screen for the at least one electric line contained therein. Consequently, the arrangement according to the invention provides a complete, gapless electromagnetic screening of the connection of two electrical devices which extends over the electric line or lines as well as the electrical devices connected therewith. As a result, the electromagnetic compatibility of the arrangement, including the electrical devices within the plant, is continuously ensured.

The metal pipe reliably and permanently protects the connection between the electrical devices within the against mechanical loads during the operation of the plant, for example, against vibrations or shocks, and against mechanical loads during the manufacture of the plant, for example, pressure.

At the same time, the connection of the electrical devices is mechanically secured by the arrangement according to the invention. The undulation of the metal pipe makes it possible to shape the arrangement in the desired manner, i.e. with defined bending radii, and can be mounted in the plant, for example, in a motor vehicle. The physical properties of the arrangement during bending are predetermined as a result. The undulation of the metal pipe also ensures that vibrations in the plant, for example, vibrations of the electric motor in the motor vehicle, can be absorbed and do not negatively affect the arrangement.

In a particular preferred embodiment, the arrangement according to the invention is used in automobile construction, i.e. for electrically conductive connections within a motor vehicle. For example, the arrangement permits a screened and mechanically stable connection of an electric motor in the front vehicle portion with an inverter, which is located together with a direct current battery in the trunk of the vehicle. The arrangement according to the invention particularly provides an additional protection against rodent bites, so that the operational safety of the vehicle is increased.

### BRIEF DESCRIPTION OF THE DRAWINGS

Embodiments of the subject matter of the invention are illustrated in the drawings. In the drawings:

FIG. 1 schematically shows an embodiment of an arrangement according to the invention for electrically connecting two electrical devices, and

FIG. 2 shows schematically an example of a connection between the arrangement according to the invention and a coupling element.

### DETAILED DESCRIPTION

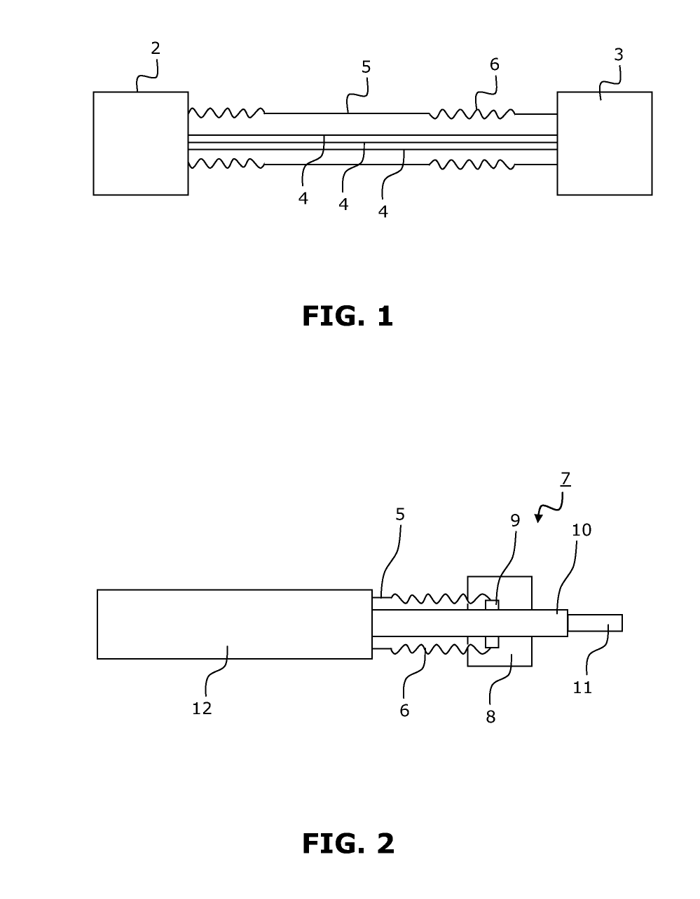

FIG. 1 shows an embodiment of an arrangement according to the invention. Three electrical lines 4 are arranged between two electrical devices 2, 3. The arrangement and the electrical devices 2, 3, are illustrated in FIG. 1 only with respect to their basic configuration, without illustration of connections to the ends of the lines 4. Each line 4 consists of an electric conductor surrounded by a screen 5. The electrical devices 2, 3 each have an electrically conductive housing. The housings may be of metal.

The electrical devices 2, 3 may be, for example, an inverter and an electromotor or an inverter with a direct current battery. Inverters and electric motors can be connected, for example, by of a three phase system, as indicated in FIG. 2. Battery and inverter may be connected, for example, through a two strand electric conductor.

The screen 5 is constructed as a metal pipe 5. The metal pipe 5 completely surrounds the electrical lines 4 and serves as a circumferentially closed electric screen. At both ends the metal pipe 5 is connected without gaps to the metal housings of the first devices 2, 3. The metal housing, as well as the metal pipe 5, thus forms a total screen which guarantees the electromagnetic compatibility of the connection between the electrical devices 2, 3.

The metal pipe 5 is at least partially provided with an undulation 6. The undulation 6 ensures that the metal pipe 5 is sufficiently partially bendable at the desired locations in order to meet the requirements of the plant, and in order to be able to absorb vibrations without impairing the mechanical strength of the arrangement. For example, for mounting the arrangement in a motor vehicle, the arrangement must be capable of bending and shaping. The metal pipe can also be completely undulated, so that the flexible use of the arrangement is ensured. The undulation 6 may be constructed with spirals, or ring shaped.

In accordance with a particular advantage, the metal pipe 5 is surrounded by an insulating layer of plastic material (see reference number 12 in FIG. 2), in order to ensure the outward electric insulation. For example, the pipe 5 may consist of copper or aluminum. The metal pipe 5 can also by itself serve as an electric line in addition to the electrical lines 4.

In accordance with a preferred embodiment, at the ends of the electrical lines 4 a coupling element each is mounted. The coupling element for example, a plug or a bushing. The coupling element is also provided with a conductive screen. The metal screen consists, for example, of a metal housing of the coupling element.

In FIG. 2 an embodiment of the arrangement connected to a plug 7 according to the invention is shown. For clarity's sake the FIG. 2 only shows an electric conductor 11 surrounded by an insulation 10. The plug 7 has a conductive housing 8 The partially undulated screening pipe 5 surrounded by an insulation is connected without gaps to the conductive housing 8, for example, of metal. This is indicated by reference numeral 9. The connection can be effected, for example by welding or by clamping, depending on whether an integral or a releasable connection is required or desired. The plug housing 8, in turn, is connected without gaps to the metal housing of one of the electrical devices. As a result, the problem free screening of the connection between the electrical devices 2, 3 is ensured.

Alternatively, the metal pipe 5 can also be connected integrally or releasably directly to the electrically conductive housings of the electrical devices 2, 3.

The arrangement according to the invention can additionally be connected to the current supply lines 4 and also have at least one optical data line (not shown). This data line may serve, for example for transmitting signals, as they are obtained when collecting rates of rotations of motors and other characteristic data of the electric motor. Consequently, the optical data line, conducted within the metal pipe 5 is protected against mechanical loads.

The metal pipe 5 is mounted on the at least one electrical line 4 in accordance with known manufacturing methods. For example, a metal band is continuously formed around the finished line 4 and is subsequently welded to its longitudinal edges. Subsequently, the pipe formed in this manner is partially or completely undulated in accordance with a desired geometry.

The diameter of the metal pipe 5 is preferably selected in such a way that the line 4 or the lines 4 are secured in the metal pipe 5. Alternatively, an existing distance between the at least one electrical line 4 and the metal pipe 5 can also be filled out with a filling material. As a result, the arrangement is in its totality better protected against mechanical loads, as caused, for example, by the vibrations and shocks of the motor vehicle in operation. A suitable filling material is, for example, a foamed insulation material, such as industrial foam. For example, the combined lines or the individual line 4 can be foamed with such a material before the metal pipe is applied as described above.

1. Arrangement for electrically connecting two devices located in a plant, said arrangement comprising:
at least one electric line formed of metal is arranged between the two electrical devices, surrounded by a screen,
wherein the screen is constructed as an at least partially metal pipe which is wound. continuously around the one electrical line whose longitudinal edges are welded together, and which is corrugated partially or completely, and
wherein the space between the at least one electrical line and the metal pipe is filled out with a filler material.

2. Arrangement according to claim 1, wherein the filler material is industrial foam.

3. Arrangement according to claim 2, wherein the combination of lines arranged in the metal pipe is surrounded by the filler material.

4. Arrangement according to claim 1, wherein the metal pipe is surrounded by an insulation layer of plastic material.

5. Arrangement according to claim 1, wherein said arrangement further comprises at least one sensor line.

6. Arrangement according to claim 5, wherein the sensor line is an optical line.

7. Arrangement according to claim 1, wherein, at the ends of the at least one electrical line, at least one coupling element each is connected to one of the screens of the coupling element, wherein the screens of the coupling element are each connected in a gap free manner to the electrically conductive housing of an electrical device.

8. Arrangement according to claim 7, characterized in that the screens (8) of the coupling element (7) are integrally connected to the ends of the metal pipe (5).

9. Arrangement according to claim 7, wherein the screens of the coupling element are integrally clamped to the ends of the metal pipe.

10. Arrangement according to claim 7, wherein the coupling elements are plugs or bushings.

11. Arrangement according to claim 1, wherein said arrangement is configured to connect two electrical devices within a motor vehicle.
